(19) United States
(12) Patent Application Publication
(10) Pub. No.: US 2024/0178506 A1
(43) Pub. Date: May 30, 2024

(54) BATTERY PACK

(71) Applicant: Prime Planet Energy & Solutions, Inc., Tokyo (JP)

(72) Inventor: Hiroshi ONIZUKA, Toyota-shi (JP)

(21) Appl. No.: 18/479,111

(22) Filed: Oct. 2, 2023

(30) Foreign Application Priority Data
Nov. 25, 2022 (JP) 2022-188413

(51) Int. Cl. H01M 50/291; H01M 10/04; H01M 50/209

(52) U.S. Cl. CPC H01M 50/291; H01M 10/0481; H01M 50/209; H01M 10/0431

(57) ABSTRACT

A battery pack disclosed herein includes a wound electrode body, a battery case, and a pressing member. The battery case includes a pair of first side walls. The wound electrode body includes a flat region and a pair of curved regions and is disposed inside the battery case in a manner that the flat region faces the first side wall. In at least one of the pair of first side walls, 80% or more of the entire parts facing the pair of curved regions including border parts with the flat region is pressed in a band shape by the pressing member, 20 to 50% of the entire part facing the flat region is pressed by the pressing member, and a space extending from a center part to an end part in a winding axis direction is formed between the part facing the flat region and the pressing member.

### CROSS REFERENCE TO RELATED APPLICATION

This application claims the benefit of priority to Japanese Patent Application No. 2022-188413 filed on Nov. 25, 2022. The entire contents of this application are hereby incorporated herein by reference.

### BACKGROUND OF THE DISCLOSURE

### 1. Field

The present disclosure relates to a battery pack.

### 2. Background

One of the conventionally used vehicle driving power sources and the like employs a battery pack including a plurality of batteries (cells) arranged in a predetermined direction, spacers disposed between the adjacent batteries in the arrangement direction, and a restriction mechanism that applies a restriction load on the plurality of batteries and the spacers from the arrangement direction (for example, Japanese Patent Application Publication No. 2015-138753, Japanese Patent Application Publication No. 2017-107648, Japanese Patent No. 6198844, and Japanese Patent Application Publication No. 2022-013634).

For example, Japanese Patent Application Publication No. 2015-138753 discloses a battery pack including a rectangular secondary battery in which a wound electrode body with a flat shape is disposed inside a battery case so that a winding axis extends along a bottom wall, and a spacer including a pressing part that presses a center part of a wide surface of the battery case that faces a flat region of the wound electrode body, and presses an upper end part and a lower end part thereof that face curved regions. According to Japanese Patent Application Publication No. 2015-138753, the surface pressure to be applied to the center part is reduced by making the elastic coefficient of the pressing part that presses the center part relatively low, thereby homogenizing the surface pressure that acts on the wide surface of the battery case.

### SUMMARY

According to the present inventor's earnest examination, there is still room for improvement in the aforementioned art. That is to say, when the battery is charged and discharged, gas such as CO₂ and CO may be generated inside the electrode body (specifically, on a surface of an electrode). In the case of the wound electrode body, however, the gas generated in the electrode body is discharged only from both ends in a winding axis direction corresponding to opening parts. Therefore, it has been turned out that if the pressing on the curved region is insufficient or, on the contrary, the pressing on the flat region is excessive, the gas generated in the electrode body is not discharged and remains in the electrode body. Meanwhile, it has been found out that if the pressing on the flat region is insufficient, the charging and discharging reaction becomes inhomogeneous. Because of these facts, particularly the battery including the wound electrode body in which the wound electrode body with a flat shape is disposed inside the battery case so that the winding axis extends along the bottom wall has a problem that, for example, repeating high-rate charging and discharging results in frequent metal precipitation (for example, Li precipitation).

The present disclosure has been made in view of the above circumstances, and a main object is to provide a battery pack in which the remaining of gas inside a wound electrode body is suppressed and the occurrence of metal precipitation is suppressed.

According to the present disclosure, a battery pack including a wound electrode body with a flat shape that includes a positive electrode and a negative electrode, a battery case that accommodates the wound electrode body, and a pressing member that presses the battery case is provided. The battery case includes a bottom wall, an upper wall, a pair of first side walls disposed so as to face each other and connecting the bottom wall and the upper wall, and a pair of second side walls disposed so as to face each other and connecting the bottom wall and the upper wall. The wound electrode body includes a flat region provided with a pair of flat outer surfaces, and a pair of curved regions provided on both ends of the flat region and each provided with a curved outer surface, and the wound electrode body is disposed inside the battery case in a manner that a winding axis is disposed along the bottom wall and each of the pair of flat outer surfaces faces the first side wall. In at least one of the pair of first side walls of the battery case here, when an entire area of parts facing the pair of curved regions is 100%, 80% or more of the area including border parts with the flat region is pressed in a band shape along the winding axis by the pressing member, when an entire area of a part facing the flat region is 100%, 20% or more and 50% or less of the area is pressed by the pressing member, and a space extending from a center part to an end part of the wound electrode body in a winding axis direction is formed between the part facing the flat region and the pressing member.

In the present disclosure, 80% or more of the area of the parts facing the curved regions of the wound electrode body including the border parts with the flat region is pressed in the band shape along the winding axis. Thus, the gas generated in the flat region does not move easily to the curved region, and the gas moves in the winding axis direction along the pressed part in the band shape and is discharged out of the electrode body easily. Therefore, the remaining of the gas in the curved region can be suppressed. In addition, when the area of the part to be pressed in the part facing the flat region is set to 50% or less and the space (part that is not pressed) extending from the center part to the end part in the winding axis direction is secured between the pressing member and the part facing the flat region, the gas moves easily in the winding axis direction in the flat region and the gas is easily guided to an opening end of the wound electrode body. Therefore, the gas generated in the flat region can be discharged smoothly out of the electrode body from the end part of the wound electrode body and the remaining of the gas in the flat region can be suppressed. In addition, when the area of the part, which is pressed, in the part facing the flat region is set to 20% or more, inhomogeneity of charging and discharging reaction due to the lack of the pressure can be suppressed. As a result, according to the above-described structure, the occurrence of metal precipitation (for example, Li precipitation) in the entire wound electrode body (curved regions and flat region) can be effectively suppressed.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a perspective view schematically illustrating a battery pack according to an embodiment;

FIG. 2 is a perspective view schematically illustrating a secondary battery in FIG. 1;

FIG. 3 is a schematic longitudinal cross-sectional view taken along line III-III in FIG. 2;

FIG. 4 is a perspective view schematically illustrating a wound electrode body;

FIG. 5 is a schematic view illustrating a structure of the wound electrode body;

FIG. 6 is a longitudinal cross-sectional view schematically illustrating a positional relation between a rectangular secondary battery and spacers;

FIG. 7 is a front view schematically illustrating the positional relation between the rectangular secondary battery and the spacer;

FIG. 8A is a plan view schematically illustrating the spacer in Examples 1 to 3, FIG. 8B is a plan view schematically illustrating the spacer in Examples 4 and 5 and Comparative Example 5, and FIG. 8C is a plan view schematically illustrating the spacer in Example 6;

FIG. 9A is a plan view schematically illustrating the spacer in Comparative Examples 1 and 2, FIG. 9B is a plan view schematically illustrating the spacer in Comparative Example 3, and FIG. 9C is a plan view schematically illustrating the spacer in Comparative Example 4;

FIG. 10 is a schematic view for explaining a positional relation between the spacers and the wound electrode bodies according to test examples; and

FIG. 11A expresses a result of surface pressure measurement of a border part when Ay is 0%, FIG. 11B expresses a result of the surface pressure measurement of the border part when Ay is 50%, FIG. 11C expresses a result of the surface pressure measurement of the border part when Ay is 100%, and FIG. 11D expresses a result of the surface pressure measurement of the border part when Ay is 150%.

### DETAILED DESCRIPTION OF THE PREFERRED EMBODIMENTS

Preferred embodiments of a battery pack disclosed herein will be described below with reference to the drawings as appropriate. Matters other than matters particularly mentioned in the present specification and necessary for the implementation of the present disclosure (for example, the general configuration and manufacturing process of a battery that do not characterize the present disclosure) can be grasped as design matters of those skilled in the art based on the prior art in the relevant field. The battery pack disclosed herein can be implemented on the basis of the disclosure of the present specification and common technical knowledge in the relevant field. Note that in the drawings below, the members and parts with the same operation are denoted by the same reference signs and the overlapping description may be omitted or simplified. Moreover, in the present specification, the notation “A to B” for a range signifies a value more than or equal to A and less than or equal to B, and is meant to encompass also the meaning of being “more than A” and “less than B”.

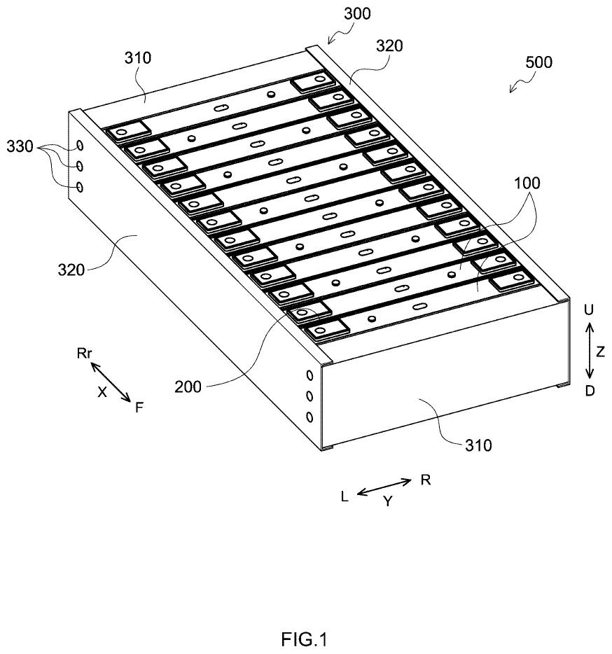

FIG. 1 is a perspective view schematically illustrating a battery pack 500 according to an embodiment. The battery pack 500 here includes a plurality of rectangular secondary batteries 100, a plurality of spacers 200, and a restriction mechanism 300. In the following description, reference signs L, R, F, Rr, U, and D in the drawings respectively denote left, right, front, rear, up, and down, and reference signs X, Y, and Z in the drawings respectively denote a short side direction (thickness direction) of the rectangular secondary battery 100, and a long side direction and an up-down direction thereof that are orthogonal to the short side direction. The short side direction X also corresponds to an arrangement direction of the rectangular secondary batteries 100. These directions are defined however for convenience of explanation, and do not limit the manner in which the battery pack 500 is disposed.

The restriction mechanism 300 is configured to apply a prescribed restriction load on the plurality of rectangular secondary batteries 100 and the plurality of spacers 200 from the arrangement direction X. The restriction mechanism 300 here includes a pair of end plates 310 facing each other, a pair of side plates 320 facing each other, and a plurality of screws 330. Each of the end plates 310 and the side plates 320 is preferably made of metal. However, a part made of resin may be included partially.

The pair of end plates 310 are arranged in the arrangement direction X. The pair of end plates 310 are disposed on both ends of the battery pack 500 in the arrangement direction X. The plurality of rectangular secondary batteries 100 are disposed between the pair of end plates 310 along the arrangement direction X. The plurality of spacers 200 are each disposed between the rectangular secondary batteries 100 that are adjacent in the arrangement direction X. The pair of end plates 310 hold the plurality of rectangular secondary batteries 100 and the plurality of spacers 200 therebetween in the arrangement direction X.

The pair of side plates 320 bridge over the pair of end plates 310. The pair of side plates 320 are fixed to the end plates 310 by the screws 330 so that the restriction load is for example about 3 to 15 kN and preferably about 5 to 10 kN. Thus, the restriction load is applied on the plurality of rectangular secondary batteries 100 and the plurality of spacers 200 from the arrangement direction X and accordingly, the battery pack 500 is held integrally. In this case, the side plates 320 and the plurality of screws 330 form the restriction mechanism of the rectangular secondary batteries 100. The restriction mechanism is, however, not limited to this example. In another example, the restriction mechanism 300 may alternatively include a plurality of restriction bands, bind bars, or the like instead of the side plates 320 and the plurality of screws 330.

In this case, the rectangular secondary battery 100 is a secondary battery that is capable of being charged and discharged repeatedly. Note that in the present specification, “battery” is a term that refers to a general power storage device capable of extracting electric energy, and refers to a concept that encompasses a primary battery and a secondary battery. In the present specification, “secondary battery” refers to a concept that encompasses a so-called storage battery (chemical battery) such as a lithium ion secondary battery and a nickel-hydrogen battery, and a capacitor (physical battery) such as a lithium ion capacitor and an electric double-layer capacitor.

As illustrated in FIG. 1, the plurality of rectangular secondary batteries 100 are arranged in the arrangement direction X so that long side walls 12b of a battery case 10, which are described below, face each other through the spacer 200. The shape, the size, the number, the arrangement, the connection method, and the like of the rectangular secondary batteries 100 included in the battery pack 500 are not limited to the aspect disclosed herein, and can be changed as appropriate. In this case, each of the pair of long side walls 12b of the rectangular secondary battery 100 is in contact with the spacer 200. However, in the rectangular secondary battery 100, it is only necessary that at least one of the pair of long side walls 12b is in contact with the spacer 200, and it is not necessary that both of the long side walls 12b are in contact with the spacer 200.

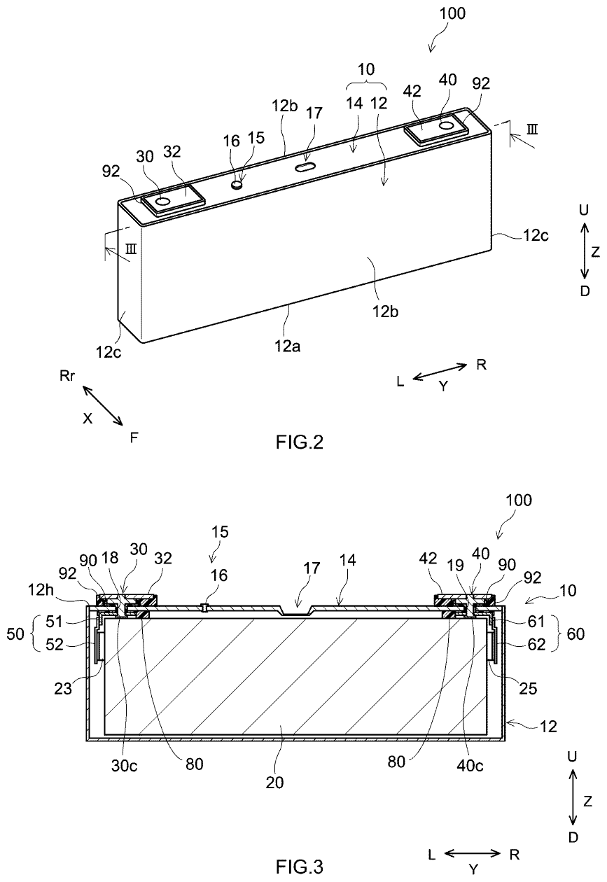

FIG. 2 is a perspective view of the rectangular secondary battery 100. FIG. 3 is a schematic longitudinal cross-sectional view taken along line III-III in FIG. 2. As illustrated in FIG. 3, the rectangular secondary battery 100 includes a battery case 10, a wound electrode body 20, a positive electrode terminal 30, a negative electrode terminal 40, a positive electrode current collecting part 50, a negative electrode current collecting part 60, and a nonaqueous electrolyte solution (not shown). In this case, the rectangular secondary battery 100 is a lithium ion secondary battery here. In this case, the rectangular secondary battery 100 is a nonaqueous electrolyte secondary battery.

The battery case 10 is a housing that accommodates the wound electrode body 20 and the nonaqueous electrolyte solution. As illustrated in FIG. 2, the external shape of the battery case 10 is a flat and bottomed cuboid shape (rectangular shape). A conventionally used material can be used for the battery case 10, without particular limitations. The battery case 10 is preferably made of metal, and for example, more preferably made of aluminum, aluminum alloy, iron, iron alloy, or the like. The thickness (plate thickness) of the battery case 10 is generally 0.1 to 2 mm and typically 0.2 to 1 mm, and may be for example 0.4 to 0.8 mm.

As illustrated in FIG. 3, the battery case 10 in this case includes an exterior body 12 having an opening 12h, and a sealing plate (lid body) 14 that seals the opening 12h. The battery case 10 preferably includes the exterior body 12 having the opening 12h and the sealing plate 14 that seals the opening 12h as described in the present embodiment. The sealing plate 14 is an example of an upper wall.

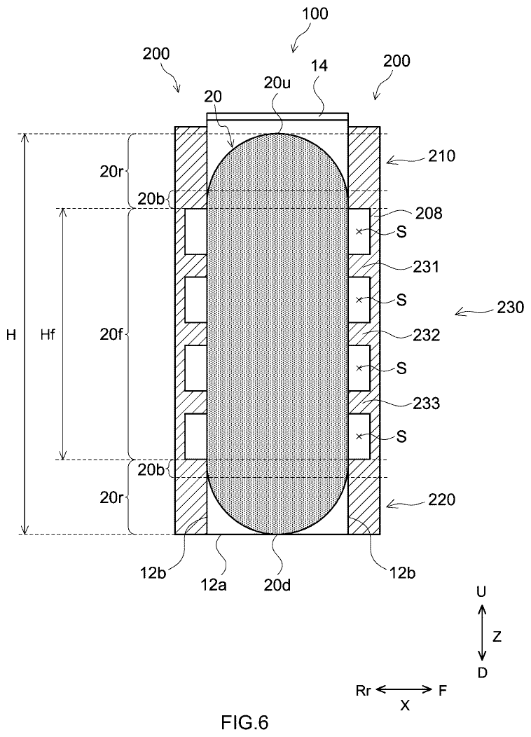

As illustrated in FIG. 2, the exterior body 12 includes a bottom wall 12a, the pair of long side walls 12b, and a pair of short side walls 12c. The bottom wall 12a is substantially rectangular in shape. The bottom wall 12a faces the sealing plate (lid body) 14. The pair of long side walls 12b are disposed so as to face each other, and connect (link) the bottom wall 12a and the sealing plate 14. The long side wall 12b has a flat shape. As illustrated in FIG. 1, the long side wall 12b is a surface that faces the spacer 200 (also see FIG. 6). The long side wall 12b is in direct contact with a part of the spacer 200. The pair of short side walls 12c are disposed so as to face each other, and connect (link) the bottom wall 12a and the sealing plate 14. The long side wall 12b is an example of a first side wall and the short side wall 12c is an example of a second side wall.

The long side wall 12b is preferably horizontally long. That is to say, the length in the long side direction Y is preferably longer than the length in the up-down direction Z. The length of the long side wall 12b in the long side direction Y is preferably 200 mm or more, and the length thereof in the up-down direction Z is preferably 100 mm or more. As the distance between the center part and the end part in the long side direction Y (in other words, the length of the wound electrode body 20 in a winding axis direction) is longer, particularly gas remains easily inside the wound electrode body 20, especially at the center part in the long side direction Y. Thus, it is particularly effective to apply the art disclosed herein. In the long side wall 12b, the ratio (ratio of height/width) of the length in the up-down direction Z to the length in the long side direction Y is preferably 1/3 to 1/1 and more preferably 1/3 to 1/2.

In a plan view, the long side wall 12b is larger in area than the short side wall 12c. Although not particularly limited, in the rectangular secondary battery 100 of a high-capacity type that may be used as an on-vehicle battery or the like, the area of the long side wall 12b may be generally 10000 mm² or more, preferably 15000 mm² or more, more preferably 20000 mm² or more, still more preferably 25000 mm² or more, and particularly preferably 30000 mm² or more. If the area of the long side wall 12b is large in this manner, particularly, the gas remains easily inside the wound electrode body 20, especially at the center part in the long side direction Y. Thus, it is particularly effective to apply the art disclosed herein. From the viewpoint of obtaining the effect of the art disclosed herein at a high level, the area of the long side wall 12b is generally 150000 mm² or less, and preferably 100000 mm² or less.

The sealing plate 14 is attached to the exterior body 12 so as to cover the opening 12h of the exterior body 12. The sealing plate 14 faces the bottom wall 12a of the exterior body 12. The sealing plate 14 is substantially rectangular in shape in a plan view. The battery case 10 is unified in a manner that the sealing plate 14 is joined (preferably, joined by welding) to a periphery of the opening 12h of the exterior body 12. The battery case 10 is hermetically sealed (closed).

As illustrated in FIG. 3, a liquid injection hole 15, a discharge valve 17, and two terminal extraction holes 18 and 19 are provided in the sealing plate 14. The liquid injection hole 15 is provided for the purpose of injecting the nonaqueous electrolyte solution after the sealing plate 14 is assembled to the exterior body 12. The liquid injection hole 15 is sealed by a sealing member 16. The discharge valve 17 is configured to break when the pressure in the battery case 10 becomes more than or equal to a predetermined value so as to discharge the gas out of the battery case 10. The sealing plate 14 is preferably provided with the liquid injection hole 15 and/or the discharge valve 17. The terminal extraction holes 18 and 19 penetrate the sealing plate 14 in the up-down direction Z. The terminal extraction holes 18 and 19 each have the inner diameter that enables the positive electrode terminal 30 and the negative electrode terminal 40, which have not been attached to the sealing plate 14 yet (before a caulking process), to pass therethrough.

The nonaqueous electrolyte solution may be similar to the conventional nonaqueous electrolyte solution, without particular limitations. The nonaqueous electrolyte solution contains a nonaqueous solvent and a supporting salt (electrolyte salt). The nonaqueous electrolyte solution may additionally contain an additive as necessary. Examples of the nonaqueous solvent include carbonates such as ethylene carbonate (EC), dimethyl carbonate (DMC), and ethyl methyl carbonate (EMC). The nonaqueous solvent preferably contains carbonates, particularly cyclic carbonates and chained carbonates. Examples of the supporting salt include fluorine-containing lithium salts such as lithium hexafluorophosphate (LiPF₆).

The positive electrode terminal 30 is disposed at an end part of the sealing plate 14 on one side in the long side direction Y (left end part in FIG. 2 and FIG. 3). The negative electrode terminal 40 is disposed at an end part of the sealing plate 14 on the other side in the long side direction Y (right end part in FIG. 2 and FIG. 3). As illustrated in FIG. 3, the positive electrode terminal 30 and the negative electrode terminal 40 extend from the inside to the outside of the sealing plate 14 through the terminal extraction holes 18 and 19. The positive electrode terminal 30 and the negative electrode terminal 40 are preferably fixed to the sealing plate 14. The positive electrode terminal 30 and the negative electrode terminal 40 are here caulked to a peripheral part of the sealing plate 14 that surrounds the terminal extraction holes 18 and 19 by the caulking process. Caulking parts 30c and 40c are formed at an end part of the positive electrode terminal 30 and the negative electrode terminal 40 on the exterior body 12 side (lower end part in FIG. 3).

As illustrated in FIG. 3, the positive electrode terminal 30 is electrically connected to a positive electrode 22 (see FIG. 5) of the wound electrode body 20 through the positive electrode current collecting part 50 inside the battery case 10. The negative electrode terminal 40 is electrically connected to a negative electrode 24 (see FIG. 5) of the wound electrode body 20 through the negative electrode current collecting part 60 inside the battery case 10. The positive electrode terminal 30 is insulated from the sealing plate 14 by an internal insulation member 80 and a gasket 90, and the negative electrode terminal 40 is insulated from the sealing plate 14 by the internal insulation member 80 and the gasket 90.

A positive electrode external conductive member 32 and a negative electrode external conductive member 42, each having a plate shape, are attached to an external surface of the sealing plate 14. As illustrated in FIG. 3, the positive electrode external conductive member 32 is electrically connected to the positive electrode terminal 30. The negative electrode external conductive member 42 is electrically connected to the negative electrode terminal 40. The positive electrode external conductive member 32 and the negative electrode external conductive member 42 are members to which a busbar or the like that electrically connects the plurality of rectangular secondary batteries 100 to each other is attached. The positive electrode external conductive member 32 and the negative electrode external conductive member 42 are insulated from the sealing plate 14 by an external insulation member 92. When the battery pack 500 is used, the adjacent rectangular secondary batteries 100 are electrically connected to each other, although the illustration is omitted in FIG. 1. For example, in the adjacent rectangular secondary batteries 100, the positive electrode external conductive member 32 of one rectangular secondary battery 100 and the negative electrode external conductive member 42 of the other rectangular secondary battery 100 are electrically connected to each other by the busbar or the like. Thus, the battery pack 500 is electrically connected in series.

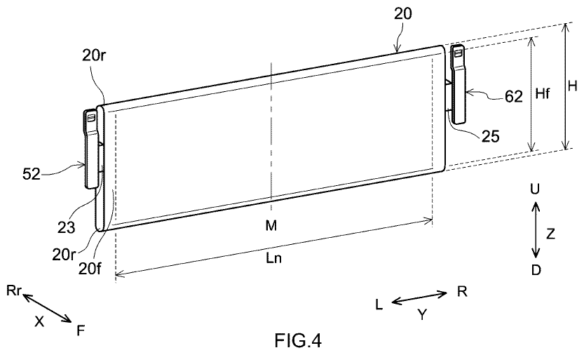

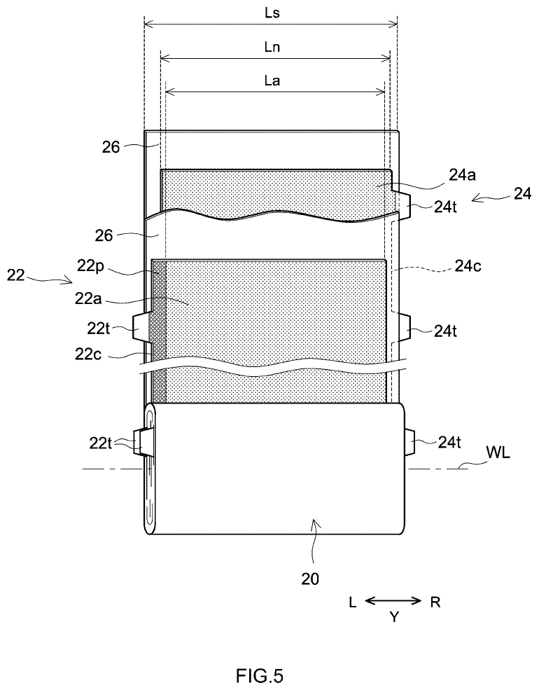

FIG. 4 is a perspective view schematically illustrating the wound electrode body 20. The number of electrode bodies to be disposed inside one battery case 10 may be one, or two or more (plural). As illustrated in FIG. 4, the external shape of the wound electrode body 20 is a flat shape. The wound electrode body 20 includes a flat region 20f having a pair of flat outer surfaces, and a pair of curved regions 20r provided on both ends of the flat region 20f and each having a curved outer surface. Note that in the present specification, “flat outer surface” is not limited to a perfectly flat surface, and is a term that encompasses a case in which a small step, curve, concave part, convex part, or the like is included when viewed microscopically, for example. In addition, “both ends of flat region 20f” are end parts in the up-down direction Z in FIG. 4, that is, end parts in a direction perpendicular to a winding axis WL (see FIG. 5) and also perpendicular to a thickness direction of the wound electrode body 20 with a flat shape (the short side direction X in FIG. 4).

Each of the pair of curved regions 20r includes a border part 20b (see FIG. 6) corresponding to a border with the flat region 20f. Note that in the present specification, “border part” refers to a part of the curved region 20r that is within about 5 mm, for example 3 mm to a side of the curved region 20r from the border line with the flat region 20f.

The wound electrode body 20 is disposed inside the battery case 10 with the winding axis WL (see FIG. 5) approximately parallel to the long side direction Y (in other words, in a direction in which the winding axis WL is along the bottom wall 12a). The flat region 20f of the wound electrode body 20, in detail each of the pair of flat outer surfaces faces the long side wall 12b of the battery case 10. One curved region 20r (upper side in FIG. 4) of the wound electrode body 20 faces the sealing plate 14, and the other curved region 20r (lower side in FIG. 4) faces the bottom wall 12a. Note that the wound electrode body 20 may be accommodated inside the battery case 10 in a state of being covered with an insulation sheet made of resin (electrode body holder).

FIG. 5 is a schematic view illustrating a structure of the wound electrode body 20. The wound electrode body 20 has a structure in which the positive electrode 22 with a band shape and the negative electrode 24 with a band shape are stacked across the separator 26 with a band shape and wound using the winding axis WL as a center. The structure of the wound electrode body 20 may be similar to the conventional structure thereof, without particular limitations.

The positive electrode 22 may be similar to the conventional positive electrode, without particular limitations. As illustrated in FIG. 5, the positive electrode 22 has a positive electrode core body 22c, and a positive electrode active material layer 22a and a positive electrode protection layer 22p that are fixed on at least one surface of the positive electrode core body 22c. The positive electrode protection layer 22p is not essential, and can be omitted in another embodiment. The positive electrode core body 22c has a band shape. The positive electrode core body 22c is preferably made of metal, and more preferably made of a metal foil. The positive electrode core body 22c is an aluminum foil here.

At one end part of the positive electrode core body 22c in the long side direction Y (left end part in FIG. 5), a plurality of positive electrode tabs 22t are provided. The positive electrode tabs 22t protrude toward one side in the long side direction Y (left side in FIG. 5). The positive electrode tabs 22t protrude in the long side direction Y more than the separator 26. The positive electrode tab 22t constitutes a part of the positive electrode core body 22c here, and is made of a metal foil (aluminum foil). As illustrated in FIG. 3 and FIG. 4, the positive electrode tabs 22t are stacked at one end part in the long side direction Y (left end part in FIG. 3 and FIG. 4), and form a positive electrode tab group 23. The positive electrode tab group 23 is electrically connected to the positive electrode terminal 30 through the positive electrode current collecting part 50.

The positive electrode active material layer 22a is formed to have a band shape along a longitudinal direction of the positive electrode core body 22c as illustrated in FIG. 5. The positive electrode active material layer 22a includes a positive electrode active material that is capable of reversibly storing and releasing charge carriers. Examples of the positive electrode active material include a lithium-transition metal complex oxide such as a lithium-nickel-cobalt-manganese complex oxide. Further, the positive electrode active material layer 22a may contain an optional component other than the positive electrode active material, for example, various additive components such as a binder or a conductive material. Examples of the binder include polyvinylidene fluoride (PVdF). Examples of the conductive material include a carbon material such as acetylene black (AB).

The positive electrode protection layer 22p is provided between the positive electrode core body 22c and the positive electrode active material layer 22a in the long side direction Y as illustrated in FIG. 5. The positive electrode protection layer 22p is formed to have a band shape along the positive electrode active material layer 22a. The positive electrode protection layer 22p contains inorganic filler (for example, alumina). The positive electrode protection layer 22p may contain an optional component other than the inorganic filler, such as a conductive material, a binder, or various additive components.

The negative electrode 24 may be similar to the conventional negative electrode, without particular limitations. As illustrated in FIG. 5, the negative electrode 24 has a negative electrode core body 24c, and a negative electrode active material layer 24a that is fixed on at least one surface of the negative electrode core body 24c. The negative electrode core body 24c has a band shape. The negative electrode core body 24c is preferably made of metal, and more preferably made of a metal foil. The negative electrode core body 24c is a copper foil here.

At one end part of the negative electrode core body 24c in the long side direction Y (right end part in FIG. 5), a plurality of negative electrode tabs 24t are provided. The negative electrode tabs 24t protrude toward one side in the long side direction Y (right side in FIG. 5). The negative electrode tabs 24t protrude in the long side direction Y more than the separator 26. The negative electrode tab 24t constitutes a part of the negative electrode core body 24c here, and is made of a metal foil (copper foil). As illustrated in FIG. 3 and FIG. 4, the negative electrode tabs 24t are stacked at one end part in the long side direction Y (right end part in FIG. 3 and FIG. 4), and form a negative electrode tab group 25. The negative electrode tab group 25 is provided at a position that is symmetrical to the positive electrode tab group 23 in the long side direction Y. The negative electrode tab group 25 is electrically connected to the negative electrode terminal 40 through the negative electrode current collecting part 60.

The negative electrode active material layer 24a is formed to have a band shape along a longitudinal direction of the negative electrode core body 24c as illustrated in FIG. 5. A length Ln of the negative electrode active material layer 24a in the long side direction Y is longer than or equal to a length La of the positive electrode active material layer 22a in the long side direction Y. From the viewpoint of higher capacity or the like, the length Ln is preferably 200 mm or more, and more preferably 250 mm or more. As the length Ln is longer, particularly, the gas remains more easily inside the wound electrode body 20, especially at the center part in the long side direction Y. Thus, it is particularly effective to apply the art disclosed herein.

The negative electrode active material layer 24a includes a negative electrode active material that is capable of reversibly storing and releasing the charge carriers. Examples of the negative electrode active material include a carbon material such as graphite. The negative electrode active material layer 24a may contain an optional component other than the negative electrode active material, for example, various additive components such as a binder, a thickener, or a dispersant. Examples of the binder include rubbers such as styrene butadiene rubber (SBR). Examples of the dispersant include celluloses such as carboxymethyl cellulose (CMC).

As illustrated in FIG. 5, the separator 26 is disposed between the positive electrode 22 and the negative electrode 24, and is a member that insulates between the positive electrode 22 the negative electrode 24. A length Ls of the separator 26 in the long side direction Y is longer than or equal to the length Ln of the negative electrode active material layer 24a in the long side direction Y. The separator 26 is suitably a porous sheet made of resin including polyolefin resin such as polyethylene (PE) or polypropylene (PP). The separator 26 may include a base material part formed by a porous sheet made of resin, and a heat-resistant layer formed on at least one surface of the base material part and containing an inorganic filler.

As illustrated in FIG. 3, the positive electrode current collecting part 50 forms a conductive path for electrically connecting the positive electrode terminal 30 and the positive electrode tab group 23 formed by the positive electrode tabs 22t. The positive electrode current collecting part 50 includes a positive electrode first current collecting part 51 and a positive electrode second current collecting part 52. The positive electrode first current collecting part 51 is attached to an inner surface of the sealing plate 14. The positive electrode second current collecting part 52 extends along the short side wall 12c of the exterior body 12. As illustrated in FIG. 3 and FIG. 4, the positive electrode second current collecting part 52 is attached to the positive electrode tab group 23 of the wound electrode body 20.

As illustrated in FIG. 3, the negative electrode current collecting part 60 forms a conductive path for electrically connecting the negative electrode terminal 40 and the negative electrode tab group 25 formed by the negative electrode tabs 24t. The negative electrode current collecting part 60 includes a negative electrode first current collecting part 61 and a negative electrode second current collecting part 62. The negative electrode first current collecting part 61 and the negative electrode second current collecting part 62 may have structures similar to those of the positive electrode first current collecting part 51 and the positive electrode second current collecting part 52 of the positive electrode current collecting part 50, respectively. As illustrated in FIG. 3 and FIG. 4, the negative electrode second current collecting part 62 is attached to the negative electrode tab group 25 of the wound electrode body 20.

The spacer 200 is a plate-shaped member. As described above, the spacers 200 are each disposed between the plurality of rectangular secondary batteries 100 in the arrangement direction X here. That is to say, in the arrangement direction X, the rectangular secondary batteries 100 and the spacers 200 are arranged alternately. The spacer 200 is an example of a pressing member. The pressing member is preferably the spacer that is disposed between the plurality of rectangular secondary batteries 100.

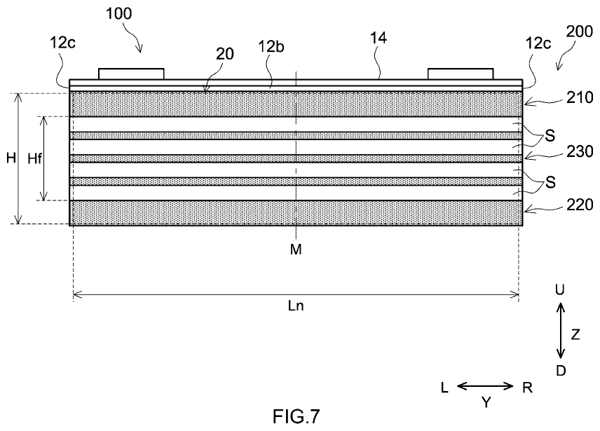

FIG. 6 is a longitudinal cross-sectional view schematically illustrating a positional relation between the rectangular secondary battery 100 and the spacers 200. FIG. 7 is a front view schematically illustrating the positional relation between the rectangular secondary battery 100 and the spacer 200. Note that each of the pair of long side walls 14b of the rectangular secondary battery 100 faces the spacer 200 in this case; however, only one of the pair of long side walls 14b may face the spacer 200. That is to say, it is only necessary that at least one of the pair of long side walls 14b faces the spacer 200. The spacer 200 is preferably a resin member, a thermosetting elastomer member, or a thermoplastic elastomer member. For example, the spacer 200 is preferably formed of a resin material such as polypropylene (PP) or polyphenylene sulfide (PPS), a thermosetting elastomer such as natural rubber, urethane rubber, silicone rubber, or fluororubber, or a thermoplastic elastomer such as polystyrene, olefin, or polyamide. Note that these materials may be foamed. In addition, these material may be a laminate in which heat insulation materials with a porous material such as a silica aerogel are stacked, for example.

The size of the spacer 200 may be determined as appropriate depending on the size, the battery capacity (degree of expansion and shrinkage), or the like of the rectangular secondary battery 100 or the wound electrode body 20, for example. As illustrated in FIG. 7, the total length of the spacer 200 in the long side direction Y may be the same as or longer than the length Ln (see FIG. 5) of the negative electrode active material layer 24a of the wound electrode body 20 in the long side direction Y. In this case, the length of the spacer 200 in the long side direction Y is substantially the same as the length of the rectangular secondary battery 100 in the long side direction Y. The length of the spacer 200 in the up-down direction Z may be the same as or longer than a height H (see also FIG. 4) of the wound electrode body 20. In this case, the length of the spacer 200 in the up-down direction Z is shorter than the length of the rectangular secondary battery 100 in the up-down direction Z.

As illustrated in FIG. 6, the spacer 200 has an uneven shape on a surface facing the long side wall 12b. In this case, the spacer 200 is line symmetrical about a center line (not shown) in the up-down direction Z. As illustrated in FIG. 7, the spacer 200 is line symmetrical about a center line M in the long side direction Y. As illustrated in FIG. 6, the spacer 200 includes a base part 208 with a plate shape, and a first part 210, a second part 220, and a third part 230 formed on a surface of the base part 208.

As illustrated in FIG. 6, the first part 210 is positioned on an upper end side in the up-down direction Z. The first part 210 is a part facing the upper curved region 20r of the wound electrode body 20 in the long side wall 12b of the battery case 10. In this case, the first part 210 is formed integrally with the base part 208. The first part 210 is a convex part. In this case, the entire first part 210 protrudes to a side of the wound electrode body 20 from the base part 208 (in the arrangement direction X). In this case, that is to say, the first part 210 is configured so that, when the spacer 200 is assembled to the battery pack 500, the entire first part 210 is in contact with the long side wall 12b of the battery case 10 and presses the contact part.

As illustrated in FIG. 6, the second part 220 is positioned on a lower end side in the up-down direction Z. The second part 220 is a part facing the lower curved region 20r of the wound electrode body 20 in the long side wall 12b of the battery case 10. In this case, the second part 220 is formed integrally with the base part 208. The second part 220 is provided symmetrically to the first part 210 through the third part 230. The second part 220 is a convex part. In this case, the entire second part 220 protrudes to a side of the wound electrode body 20 from the base part 208 (in the arrangement direction X). In this case, that is to say, the second part 220 is configured so that, when the spacer 200 is assembled to the battery pack 500, the entire second part 220 is in contact with the long side wall 12b of the battery case 10 and presses the contact part.

As illustrated in FIG. 6 and FIG. 7, the first part 210 and the second part 220 have the same shape in this case. The first part 210 and the second part 220 are equal to each other in length in the long side direction Y, length in the height direction Z (width), and protrusion length in the arrangement direction X. In detail, as illustrated in FIG. 7, the first part 210 and the second part 220 are substantially rectangular in shape in a plan view. Each of the first part 210 and the second part 220 extends in a band shape along the long side direction Y (the winding axis direction of the wound electrode body 20). In the long side direction Y, the length of each of the first part 210 and the second part 220 may be more than or equal to the length Ln of the negative electrode active material layer 24a, and from the viewpoint of saving the space, may be less than or equal to the length of the long side wall 12b of the battery case 10.

As illustrated in FIG. 6, in the height direction Z, the first part 210 and the second part 220 have the same width as the pair of curved regions 20r, respectively. However, the first part 210 and/or the second part 220 may be shorter in width than the curved region 20r or longer in width than the curved region 20r. In a preferred aspect, the first part 210 and/or the second part 220 of the spacer 200 is longer in width than the curved region 20r. In this case, from the viewpoints of saving the space, and the like, the width of the first part 210 and/or the second part 220 is preferably less than or equal to twice (200%) the width of one curved region 20r, and more preferably less than or equal to 1.5 times (150%) the width of the curved region 20r.

As illustrated in FIG. 6, the third part 230 is positioned at the center part in the up-down direction Z, that is, between the first part 210 and the second part 220. The third part 230 is a part facing the flat region 20f of the wound electrode body 20 in the long side wall 12b of the battery case 10. The third part 230 has an uneven shape. That is to say, the third part 230 includes a part that presses the long side wall 12b and a part that does not press the long side wall 12b when the spacer 200 is assembled to the battery pack 500.

The third part 230 includes a first convex part 231, a second convex part 232, and a third convex part 233 that protrude from the base part 208 to a side of the wound electrode body 20 (in the arrangement direction X) and that are integrally formed from the base part 208. The first convex part 231, the second convex part 232, and the third convex part 233 are disposed at positions that are separated from each other in the up-down direction Z. The first convex part 231, the second convex part 232, and the third convex part 233 are configured so that, when the spacer 200 is assembled to the battery pack 500, the first convex part 231, the second convex part 232, and the third convex part 233 are in contact with the long side wall 12b of the battery case 10 and press the contact parts.

In the up-down direction Z, a space S is secured between the first part 210 and the first convex part 231, between the first convex part 231 and the second convex part 232, between the second convex part 232 and the third convex part 233, and between the third convex part 233 and the second part 220. The space S is configured so that, when the spacer 200 is assembled to the battery pack 500, the spacer 200 is not in contact with the long side wall 12b of the battery case 10 and the long side wall 12b is not pressed.

As illustrated in FIG. 7, the space S extends like a line (for example, like a straight line) along the long side direction Y (the winding axis direction of the wound electrode body 20). The space S extends from the center part to the end part of the wound electrode body 20 in the long side direction Y. The space S is a penetration hole that penetrates from a left end to a right end in the long side direction Y of the wound electrode body 20. In other words, the space S opens at both ends in the long side direction Y. Note that in the present specification, “center part” in the long side direction Y refers to a part corresponding to a predetermined ratio (for example, 10% or less of the length Ln of the negative electrode active material layer 24a) from the center line M of the wound electrode body 20, and “end part” refers to a part that is positioned on an end side in the long side direction Y compared to the center part and that corresponds to a predetermined ratio (for example, 10% or less of the length Ln of the negative electrode active material layer 24a) from the end of the wound electrode body 20.

As illustrated in FIG. 6 and FIG. 7, the first convex part 231, the second convex part 232, and the third convex part 233 have the same shape in this case. The first convex part 231, the second convex part 232, and the third convex part 233 are equal to each other in length in the long side direction Y, length in the height direction Z (width), and protrusion length in the arrangement direction X. As illustrated in FIG. 7, the first convex part 231, the second convex part 232, and the third convex part 233 are substantially rectangular in shape in a plan view. That is, the third part 230 includes a protrusion part with a stripe (streak) shape. Each of the first convex part 231, the second convex part 232, and the third convex part 233 extends in a band shape along the long side direction Y (the winding axis direction of the wound electrode body 20). However, the protrusion parts of the third part 230 may have another shape such as a dot shape, a wavy shape, a dotted line shape, or a combination of these to be described in Examples below, for example. The third part 230 preferably includes the protrusion parts with a dot shape or a stripe shape, and more preferably includes the protrusion parts with a dot shape. In particular, the third part 230 preferably includes the protrusion parts with a band shape as the first convex part 231 and the second convex part 232, and the protrusion part with a dot shape as the third convex part 233 from the viewpoint of a degassing property. When the protrusion parts have a stripe shape, it is preferable that the protrusion parts extend in the long side direction Y (the winding axis direction of the wound electrode body 20) as described in the present embodiment.

In the long side wall 12b of the battery case 10 in the battery pack 500, when the entire area of parts facing the pair of curved regions 20r (the upper curved region 20r and the lower curved region 20r) is 100%, 80% or more of the area including parts facing the border parts 20b is pressed in a band shape along the winding axis WL by the spacer 200. In this case, a part facing the curved region 20r including the border part 20b on the upper side is pressed by the first part 210, and a part facing the curved region 20r including the border part 20b on the lower side is pressed by the second part 220. Thus, the gas generated in the flat region 20f does not easily move to the curved regions 20r, and the gas easily moves in the winding axis direction along the pressed part with a band shape and is discharged out of the electrode body easily. Therefore, the remaining of the gas in the curved regions 20r is suppressed. As a result, in the curved regions 20r, the occurrence of metal precipitation (for example, Li precipitation) can be suppressed effectively.

Note that in the present specification, as illustrated in FIG. 6, “the area of the parts facing the pair of curved regions 20r” refers to the area of parts facing the pair of curved regions 20r (in detail, parts where the negative electrode active material layer 24a exists in the curved regions 20r) when viewed from a direction perpendicular to the long side wall 12b.

In the parts facing the pair of curved regions 20r, the area of parts pressed by the spacer 200 (that is, the area of the pressed parts/the area of the parts facing the pair of curved regions 20r, that is also referred to as “an area ratio Ay” below) may be 80% or more without particular limitations, and is preferably 90% or more, more preferably 95% or more, and particularly preferably 100% or more. In the present embodiment, the entire parts facing the pair of curved regions 20r are pressed by the first part 210 and the second part 220 of the spacer 200, respectively. Moreover, each of positions facing vertex parts of the pair of curved regions 20r, that is, an upper end (an end on the sealing plate 14 side) 20u and a lower end (an end on the bottom wall 12a side) 20d of the wound electrode body 20 is pressed by the spacer 200. Therefore, as shown by surface pressure measurement results to be described below, surface pressure can be effectively applied to the border part 20b in particular, and the effect of the art disclosed herein can be obtained at the high level. For example, the area ratio Ay may be 200% or less, or 150% or less.

In a preferred aspect, the area ratio Ay is more than 100%, and a part ranging from the part facing the curved region 20r to a part that does not face the curved region 20r and the flat region 20f (a part on a side opposite to the flat region 20f in the height direction Z) is pressed by the first part 210 and/or the second part 220 of the spacer 200 in a band shape along the winding axis WL. Therefore, as shown by the surface pressure measurement results to be described below, the surface pressure can be effectively applied to the border part 20b in particular, and the effect of the art disclosed herein can be obtained at the high level.

In the long side wall 12b of the battery case 10 in the battery pack 500, when the entire area of the part facing the flat region 20f is 100%, 20% to 50% of the area is pressed by the spacer 200. Moreover, between the spacer 200 and the part facing the flat region 20f, the space S extending from the center part to the end part of the wound electrode body 20 in the winding axis direction is formed. When the area of the part that is pressed is set to 50% or less and the space S (part that is not pressed) is secured between the spacer 200 and the part facing the flat region 20f, the gas moves easily to the winding axis direction in the flat region 20f and the gas is easily guided to opening ends (left and right end parts in FIG. 4) of the wound electrode body 20. Thus, the gas can be smoothly discharged from the opening ends of the wound electrode body 20 to the outside of the electrode body and the remaining of the gas in the flat region 20f can be suppressed. Moreover, when the area of the part that is pressed is set to 20% or more, inhomogeneity of charging and discharging reaction due to the lack of the pressure can be suppressed. As a result, in the flat region 20f, the occurrence of the metal precipitation (for example, Li precipitation) can be suppressed effectively.

In addition, when the area of the part that is pressed is set to 50% or less, a degree of freedom of expansion and shrinkage of the wound electrode body 20 can be secured in the charging and discharging. Thus, when the wound electrode body 20 is expanded, unevenness of salt concentration is suppressed and resistance increase after a high-rate durability test can be suppressed. Therefore, an excellent high rate characteristic can be achieved for a long time.

Note that in the present specification, as illustrated in FIG. 7, “the area of the part facing the flat region 20f” refers to the area of the part facing the flat region 20f when the long side wall 12b is viewed from the front. In detail, this area refers to the area of a part facing a part where the negative electrode active material layer 24a exists in the flat region 20f (in FIG. 4, a height Hf of the flat region 20f×the length Ln of the negative electrode active material layer 24a in the long side direction Y).

In the part facing the flat region 20f, the area of a part pressed by the spacer 200 (that is, the area of the pressed part/the area of the part facing the flat region 20f, that is also referred to as “an area ratio Ax” below) may be in the range of 20% to 50% without particular limitations, and for example, the area may be 30% or more from the viewpoint of suppressing the metal precipitation at a high level. The rest of the part facing the flat region 20f is not pressed by the spacer 200 and the space S is secured between the rest and the spacer 200.

A difference (Ay-Ax) between the area ratio Ax (that is, the region pressed by the spacer 200 in the part facing the flat region 20f) and the area ratio Ay (that is, regions pressed by the spacer 200 in the parts facing the pair of curved regions 20r) is 30% or more and preferably 50% or more, and may be for example 60% or more, 70% or more, and furthermore 80% or more. Thus, the gas that is generated in the electrode body can move easily in the winding axis direction with priority, and the remaining of the gas in the curved region 20r can be suppressed at a high level. For example, the difference (Ay-Ax) may be 170% or less, 150% or less, or 100% or less.

The battery pack 500 is usable in various applications, and for example, can be suitably used as a motive power source for a motor (power source for driving) that is mounted in a vehicle such as a passenger car or a truck. The vehicle is not limited to a particular type, and may be, for example, a plug-in hybrid electric vehicle (PHEV), a hybrid electric vehicle (HEV), or a battery electric vehicle (BEV).

Several Examples relating to the present disclosure will be explained below, but the disclosure is not meant to be limited to these Examples.

First, a plurality of positive electrode sheets with a band shape including the positive electrode active material layer were manufactured. The positive electrode active material layer includes lithium-nickel-cobalt-manganese complex oxide (NCM) as the positive electrode active material, AB as the conductive material, and PVdF as the binder in a mass ratio of NCM:AB:PVdF=97.5:1.5:1.0. In addition, a plurality of negative electrode sheets with a band shape including the negative electrode active material layer were manufactured. The negative electrode active material layer includes graphite (C) as the negative electrode active material, CMC as the dispersant, and SBR as the binder in a mass ratio of C:CMC:SBR=98.3:0.7:1.0.

Next, the positive electrode sheet and the negative electrode sheet manufactured as above were disposed to face each other via a separator sheet and wound in a flat shape, and thus, three wound electrode bodies were manufactured. Note that the separator sheet including a heat-resistant layer containing alumina and PVdF on a surface of a base part made of PE was used. The height H (see FIG. 4) of the three wound electrode bodies was 93.6±0.25 mm, the height Hf (see FIG. 4) of the flat region was 81.40±0.25 mm, and the length Ln (see FIG. 4) of the negative electrode active material layer in the long side direction Y was 287.80±1.50 mm.

Next, as the nonaqueous electrolyte solution, a nonaqueous electrolyte solution in which LiPF₆ was dissolved at a concentration of 1.0 mol/L in a mixed solvent including EC, EMC, and DMC in a volume ratio of EC:EMC:DMC=1:1:1 was prepared. Then, a plurality of secondary batteries with a cuboid shape were structured by accommodating each of the three wound electrode bodies manufactured as above and the nonaqueous electrolyte solution in a battery case. Note that in the external shape of the battery case, the length in the long side direction is 308.00±0.10 mm and the height is 103.00±0.08 mm. In the long side direction, each of left and right ends of the wound electrode body is 7.0 mm apart from the short side wall, an upper end of the wound electrode body is 11.0 mm apart from the sealing plate (upper wall), and a lower end of the wound electrode body is 7.0 mm apart from the bottom wall.

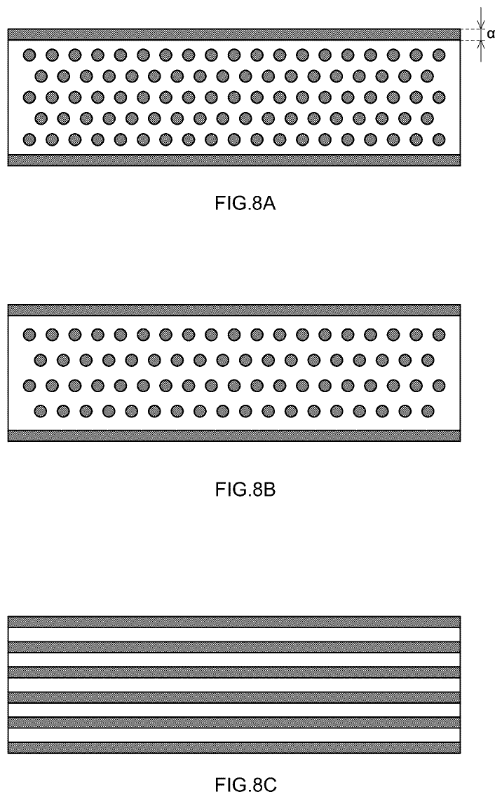

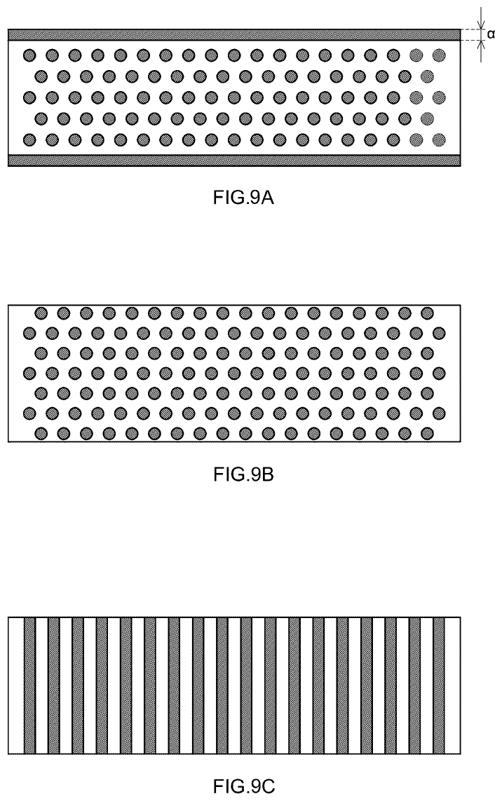

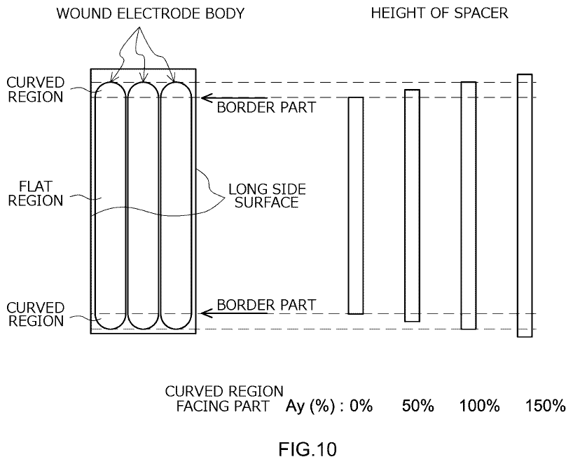

Then, spacers including convex parts with the shape illustrated in FIGS. 8A to 8C and FIGS. 9A to 9C were prepared, the secondary batteries structured as above were restricted in a state where the secondary battery faced the spacer, and the restriction was performed with a restriction load of 7 kN, and thus, the battery packs (Examples 1 to 6 and Comparative Examples 1 to 6) were manufactured. Note that the external shape of the prepared spacer is substantially the same as that of the spacer in FIG. 7 except for a case in which the external shape of the spacer is mentioned below in particular. In the manufactured battery pack, each of a pair of side surfaces of the secondary battery is pressed by the spacer. FIG. 10 is a schematic view for explaining a positional relation between the spacers and the wound electrode bodies according to test examples (Examples 1 to 6 and Comparative Examples 1 to 6). Note that FIG. 10 illustrates only the positional relation between the wound electrode bodies and the spacers, and the illustration of the uneven shape of the spacer is omitted.

FIG. 8A is a plan view schematically illustrating the spacer in Examples 1 to 3. In Examples 1 to 3, the spacer is provided with a plurality of convex parts with a dot shape facing the flat region of the wound electrode body. Thus, 30% of the entire area of the part facing the flat region is pressed by the convex parts. Moreover, a space between the convex parts with a dot shape forms a space (part that is not pressed) extending from the center part to the end part of the wound electrode body in the winding axis direction.

In addition, in Examples 1 to 3, the spacer is provided with a pair of convex parts facing the pair of curved regions of the wound electrode body. The convex part has a band shape with a width a extending along the winding axis. The widths a in Example 1 to 3 are different from each other. The width a is the same as the width of one curved region of the wound electrode body (100%) in Example 1, the width a is 1.5 times the width of one curved region of the wound electrode body (150%) in Example 2, and the width a is 0.8 times the width of one curved region of the wound electrode body (80%) in Example 3. Thus, in Example 1, the whole (100%) of the pair of curved regions including the border parts with the flat region is pressed by the spacer. In Example 2, the part ranging from the part facing the curved region to the part that does not face the wound electrode body (the curved region and the flat region) is pressed by the spacer. In Example 3, 80% of the pair of curved regions including the border parts with the flat region is pressed by the spacer.

FIG. 8B is a plan view schematically illustrating the spacer in Examples 4, 5, and the like. In Examples 4 and 5, the number of convex parts with a dot shape facing the flat region of the wound electrode body is changed from that in Example 1. Specifically, in Example 4, the number of convex parts is reduced and 20% of the entire area of the part facing the flat region is pressed by the convex parts. In Example 5, the number of convex parts is increased and 50% of the entire area of the part facing the flat region is pressed by the convex parts. Except for this point, Examples 4 and 5 are similar to Example 1.

FIG. 8C is a plan view schematically illustrating the spacer in Example 6. In Example 6, the spacer is provided with a plurality of convex parts with a lateral streak shape (a stripe shape extending in the winding axis direction) facing the flat region of the wound electrode body. Thus, 50% of the entire area of the part facing the flat region is pressed by the convex parts. Except for this point, Example 6 is similar to Example 1.

FIG. 9A is a plan view schematically illustrating the spacer in Comparative Examples 1 and 2. In Comparative Examples 1 and 2, the width a of the pair of convex parts facing the pair of curved regions is shorter than that in Examples 1 to 3. Specifically, in Comparative Example 1, the width a is a half of the width of one curved region of the wound electrode body (50%), and in Comparative Example 2, the part with the width & is cut (the length of the width a is 0% of the width of one curved region of the wound electrode body). Thus, in Comparative Example 1, 50% of the entire area of the parts facing the pair of curved regions is pressed by the convex parts. In Comparative Example 2, the entire area of the parts facing the pair of curved regions is not pressed by the spacer. Except for this point, Comparative Examples 1 and 2 are similar to Example 1.

FIG. 9B is a plan view schematically illustrating the spacer in Comparative Example 3. In Comparative Example 3, the spacer is provided with a plurality of convex parts with a dot shape facing a part ranging from the flat region to the pair of curved regions of the wound electrode body. Thus, 30% of the entire area of the part facing the flat region is pressed by the convex parts, and 17% of the entire area of the parts facing the pair of curved regions is pressed by the convex parts.

FIG. 9C is a plan view schematically illustrating the spacer in Comparative Example 4. In Comparative Example 4, the spacer is provided with a plurality of convex parts with a longitudinal streak shape (a stripe shape extending in a direction orthogonal to the winding axis) facing the part ranging from the flat region to the pair of curved regions of the wound electrode body. Thus, 50% of the entire area of the part facing the flat region is pressed by the convex parts, and 50% of the entire area of the parts facing the pair of curved regions is pressed by the convex parts.

As illustrated in FIG. 8B, the number of convex parts with a dot shape facing the flat region of the wound electrode body is smaller in Comparative Example 5 than in Example 4. Thus, in Comparative Example 5, 5% of the entire area of the part facing the flat region is pressed by the convex parts. Except for this point, Comparative Example 5 is similar to Example 4.

In Comparative Example 6, although illustration is omitted, the spacer has a flat plate shape facing the part ranging from the flat region to the pair of curved regions of the wound electrode body. Thus, in Comparative Example 6, the entire area of the part facing the flat region and the parts facing the pair of curved regions is pressed.

Table 1 shows the summary of the spacers in the respective examples. In Table 1, “flat region facing part Ax (%)” represents the ratio when the entire area of the part facing the flat region (area of Hf×Ln in FIG. 4) in the case of viewing the long side wall from the front is 100%. In addition, “curved region facing part Ay (%)” represents the ratio when the entire area of the parts facing the pair of curved regions in the case of viewing in a direction perpendicular to the long side wall is 100%. However, in Comparative Example 4, the convex parts that press the pair of curved regions have the regular longitudinal streak shape; thus, the ratio is 50%. When Ay is over 100%, the spacer protrudes equally from an upper end part and a lower end part of the curved regions as illustrated in FIG. 10.

TABLE 1

| | | | | | | | Evaluation result after cycles | | |
|---|---|---|---|---|---|---|---|---|---|
| | Spacer | | | | | | Li precipitation | | |
| | Shape of convex part | | | Ratio of pressed area (%) | | | occurred or not | | |
| | | Flat | Curved | | Curved | | Flat | Curved | |
| | | region | region | Flat region | region | | region of | region of | Resistance |
| | Overall | facing | facing | facing part | facing part | (Ay-Ax) | electrode | electrode | increase |
| | shape | part | part | Ax (%)*1 | Ay (%)*2 | % | body | body | rate (%) |
| Example 1 | FIG. | Dot shape | Flat plate | 30 | 100 | 70 | Not occurred | Not occurred | 108.7 |
| Example 2 | 8A | | shape | 30 | 150 | 120 | Not occurred | Not occurred | 109.2 |
| Example 3 | | | | 30 | 80 | 50 | Not occurred | Not occurred | 107.7 |
| Example 4 | FIG. | Dot shape | Flat plate | 20 | 100 | 80 | Not occurred | Not occurred | 106.5 |
| Example 5 | 8B | | shape | 50 | 100 | 50 | Not occurred | Not occurred | 109.5 |
| Example 6 | FIG. | Lateral | Flat plate | 50 | 100 | 50 | Not occurred | Not occurred | 107.2 |
| | 8C | streak | shape | | | | | | |
| | | shape | | | | | | | |
| Comparative | FIG. | Dot shape | Flat plate | 30 | 50 | 20 | Not occurred | Occurred | 108.3 |
| Example 1 | | | | | | | | | |
| Comparative | 9A | | shape | 30 | 0 | −30 | Not occurred | Occurred | 108.5 |
| Example 2 | | | | | | | | | |
| Comparative | FIG. | Dot shape | | 30 | 17 | −13 | Not occurred | Occurred | 106.5 |
| Example 3 | 9B | | | | | | | | |
| Comparative | FIG. | Longitudinal streak | | 50 | 50 | 0 | Occurred | Occurred | 107.3 |
| Example 4 | 9C | shape | | | | | | | |
| Comparative | FIG. | Dot shape | Flat plate | 5 | 100 | 95 | Occurred | Not occurred | 104 |
| Example 5 | 8B | | shape | | | | | | |
| Comparative | — | Flat plate shape | | 100 | 100 | 0 | Occurred | Not occurred | 120.4 |
| Example 6 | | | | | | | | | |

*1When the long side wall is viewed from the front
*2When viewed from a direction perpendicular to the long side wall

### High-Rate Durability Test

Under an environment with a temperature of 25° C., the state of charge (SOC) of the secondary battery was adjusted to 20%, constant-current charging was performed for 10 minutes at a charging rate of 2 C, which was followed by the 10-minute rest, and then constant-current discharging was performed for 60 minutes at a discharging rate of 1/3 C, which was followed by the 10-minute rest, and this charging and discharging is regarded as one cycle. This cycle was repeated 50 times.

### Determination of Presence or Absence of Li Precipitation

The secondary battery after the high-rate durability test was disassembled and for each of the flat region and the curved regions of the wound electrode body, whether Li precipitation occurred or not was determined with eyes. The results are shown in Table 1.

As shown in Table 1, Li precipitation was observed in the curved regions of the wound electrode body in Comparative Examples 1 to 4. It is considered that this is because the pressing on the part facing the curved region is insufficient and the gas generated in the flat region easily moves to the curved region; therefore, the moved gas is not discharged out of the electrode body and remains in the curved region. In Comparative Example 4, the Li precipitation was observed also in the flat region of the wound electrode body. It is considered that this is because the convex parts of the spacer have the regular longitudinal streak shape, so that the movement of gas in the winding axis direction (from the center part to the end part of the wound electrode body) is interrupted and the gas remains in the flat region. In Comparative Examples 5 and 6, the Li precipitation was observed in the flat region of the wound electrode body. In Comparative Example 5, it is considered that this is because the pressing on the part facing the flat region is insufficient and the inter-electrode distance increases; therefore, the charging and discharging reaction in the flat region becomes inhomogeneous. In Comparative Example 6, it is considered that since the spacer has a flat plate shape, the movement of the gas in the winding axis direction is interrupted in the flat region and the gas remains in the flat region.

On the other hand, in Examples 1 to 6, the Li precipitation was observed in neither the curved regions nor the flat region of the wound electrode body. A first possible reason is that when the gas generated in the flat region moves toward the pair of curved regions (upper end side and/or lower end side), 80% or more of the parts facing the curved regions including the border parts with the flat region is pressed in the band shape; thus, the gas cannot move to the curved regions and moves in the winding axis direction along the pressed part in the band shape and is discharged out of the electrode body. A second possible reason is that when the area of the part to be pressed in the part facing the flat region is set to 50% or less and the space (part that is not pressed) extending from the center part to the end part of the wound electrode body in the winding axis direction exists between the spacer and the part facing the flat region, the gas moves easily in the winding axis direction in the flat region. A third possible reason is that when 20% or more of the part facing the flat region is pressed, the charging and discharging reaction is homogenized in the flat region. These results indicate the significance of the art disclosed herein.

### Measurement of Resistance Increase Rate

The secondary battery before and after the high-rate durability test was adjusted to have an SOC of 50%, constant-current discharging was performed for 10 seconds at 300 A, and then, the discharge resistance was measured. Next, the battery voltage ΔV dropped in 10 seconds was read and based on the battery voltage ΔV and the discharge current value, the IV resistance (10-second resistance) was calculated. By comparison of IV resistance before and after the durability test, the resistance increase rate was calculated. The results are shown in Table 1.

As shown in Table 1, in Comparative Example 6, the resistance increase due to the deterioration after the high-rate durability test was relatively large. It is considered that this is because the entire area of the part facing the flat region is pressed and thus, there is no degree of freedom with respect to the expansion and shrinkage of the electrode body in the charging and discharging and the unevenness of salt concentration occurs when the electrode body expands. On the other hand, in Examples 1 to 6, etc., the area of the part to be pressed in the part facing the flat region was set to 50% or less, so that a degree of freedom of expansion and shrinkage of the electrode body was secured and the resistance increase after the high-rate durability test was suppressed.

### Measurement of Surface Pressure Distribution

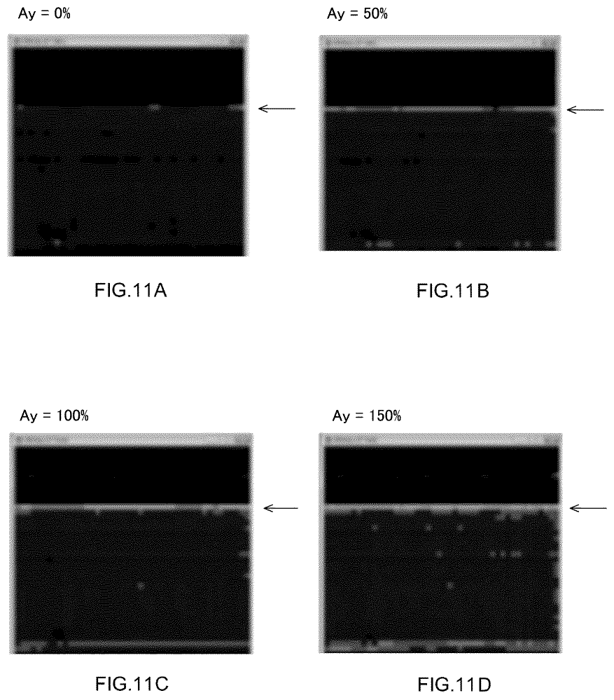

Here, the surface pressure of the border part when the size of the spacer was varied was checked using a surface pressure sensor. Specifically, using a surface pressure distribution measurement system manufactured by NITTA Corporation, surface pressure was measured under a condition with a restriction load of 7 kN regarding the following cases: (A) when the parts facing the pair of curved regions were not pressed by the spacer at all (Ay=0%), as described in Comparative Example 2; (B) when a half of the parts facing the pair of curved regions was pressed by the spacer (Ay=50%), as described in Comparative Example 1; (C) when the entire parts facing the pair of curved regions were pressed by the spacer (Ay=100%), as described in Example 1; and (D) when the part ranging from the parts facing the curved regions to the part that does not face the curved region and the flat region was pressed in the band shape by the spacer (Ay=150%), as described in Example 2. The results are shown in FIGS. 11A to 11D. Note that the thinner color corresponds to a higher load of pressure in FIGS. 11A to 11D.

As indicated by an arrow in FIG. 11A, when Ay is 0%, pressure is hardly applied to the border part. In contrast to this, as indicated by an arrow in each of FIG. 11B to 11D, it has been confirmed that the border part was pressed with higher pressure as the area of the part to be pressed is enlarged in a manner that Ay increases to 50%, 100% and further to 150%. Accordingly, it has been found out that when not just the parts facing the pair of curved regions but also the part not facing the wound electrode body (curved region and flat region) is pressed as described in Example 2, the effect of the art disclosed herein can be obtained at the high level.

Although the preferable embodiments of the present disclosure have been described above, they are merely examples. The present disclosure can be implemented in various other modes. The present disclosure can be implemented based on the contents disclosed in this specification and the technical common sense in the relevant field. The techniques described in the scope of claims include those in which the embodiments exemplified above are variously modified and changed. For example, a part of the aforementioned embodiment can be replaced by another modified example, and the other modified example can be added to the aforementioned embodiment. Additionally, the technical feature may be deleted as appropriate unless such a feature is described as an essential element.

For example, in the aforementioned embodiment, the first part 210 and the second part 220 of the spacer 200 are substantially rectangular in shape and extend in the band shape along the long side direction Y (the winding axis direction of the wound electrode body 20) with the uniform width. However, the present disclosure is not limited to this example. In another example, the peripheral part (corner part in particular) of the long side wall 12b of the battery case 10 is more rigid than the center part and to this peripheral part, the restriction load is not applied easily. Therefore, the pressing effect is considered to be small. Thus, the first part 210 and the second part 220 of the spacer 200 may have a notch at a part facing an outer periphery, for example. In one example, the first part 210 and/or the second part 220 may have a part that extends more than or equal to the length Ln of the negative electrode active material layer 24a along the border part with the flat region and have a shape in which the part facing the outer periphery (corner part in particular) of the long side wall 12b is cut off. This shape can improve the degassing property of the curved region 20r.

As described above, the following items are given as specific aspects of the art disclosed herein.

Item 1: The battery pack including: the wound electrode body with the flat shape that includes the positive electrode and the negative electrode; the battery case that accommodates the wound electrode body; and the pressing member that presses the battery case, in which the battery case includes the bottom wall, the upper wall, the pair of first side walls disposed so as to face each other and connecting the bottom wall and the upper wall, and the pair of second side walls disposed so as to face each other and connecting the bottom wall and the upper wall, the wound electrode body includes the flat region provided with the pair of flat outer surfaces, and the pair of curved regions provided on both ends of the flat region and each provided with the curved outer surface, the wound electrode body is disposed inside the battery case in a manner that the winding axis is disposed along the bottom wall and each of the pair of flat outer surfaces faces the first side wall, and in at least one of the pair of first side walls of the battery case here, when the entire area of the parts facing the pair of curved regions is 100%, 80% or more of the area including the border parts with the flat region is pressed in the band shape along the winding axis by the pressing member, when the entire area of the part facing the flat region is 100%, 20% or more and 50% or less of the area is pressed by the pressing member, and the space extending from the center part to the end part of the wound electrode body in the winding axis direction is formed between the part facing the flat region and the pressing member.

Item 2: The battery pack according to Item 1, in which in at least one of the pair of first side walls of the battery case, each of the positions facing the vertex parts of the pair of curved regions is pressed by the pressing member.

Item 3: The battery pack according to Item 1 or 2, in which the pressing member includes the protrusion part with the dot shape or the stripe shape at the part facing the flat region, and in at least one of the pair of first side walls of the battery case, the part facing the flat region is pressed by the protrusion part.

Item 4: The battery pack according to any of Items 1 to 3, in which in at least one of the pair of first side walls of the battery case, each of the entire parts facing the pair of curved regions is pressed by the pressing member.

Item 5: The battery pack according to any one of claims 1 to 4, in which in at least one of the pair of first side walls of the battery case, when the area ratio of the region pressed by the pressing member in the part facing the flat region is Ax % and the area ratio of the regions pressed by the pressing member in the parts facing the pair of curved regions is Ay %, the difference between Ax and Ay (Ay-Ax) is 50% or more.

Item 6: The battery pack according to any one of Items 1 to 5, in which in at least one of the pair of first side walls of the battery case, the part ranging from the part facing the curved region to the part that does not face the curved region and the flat region is pressed in the band shape along the winding axis by the pressing member.

### REFERENCE SIGNS LIST

10 Battery case
12 Exterior body
12b Long side wall (first side wall)
14 Sealing plate (upper wall)
20 Wound electrode body
20b Border part
20f Flat region
20r Curved region
100 Rectangular secondary battery
200 Spacer (pressing member)
210 First part
220 Second part
230 Third part
300 Restriction mechanism
500 Battery pack

What is claimed is:

1. A battery pack comprising:
a wound electrode body with a flat shape that includes a positive electrode and a negative electrode;
a battery case that accommodates the wound electrode body; and
a pressing member that presses the battery case, wherein
the battery case includes a bottom wall, an upper wall, a pair of first side walls disposed so as to face each other and connecting the bottom wall and the upper wall, and a pair of second side walls disposed so as to face each other and connecting the bottom wall and the upper wall,
the wound electrode body includes a flat region provided with a pair of flat outer surfaces, and a pair of curved regions provided on both ends of the flat region and each provided with a curved outer surface,
the wound electrode body is disposed inside the battery case in a manner that a winding axis is disposed along the bottom wall and each of the pair of flat outer surfaces faces the first side wall, and
in at least one of the pair of first side walls of the battery case here, when an entire area of parts facing the pair of curved regions is 100%, 80% or more of the area including border parts with the flat region is pressed in a band shape along the winding axis by the pressing member, when an entire area of a part facing the flat region is 100%, 20% or more and 50% or less of the area is pressed by the pressing member, and a space extending from a center part to an end part of the wound electrode body in a winding axis direction is formed between the part facing the flat region and the pressing member.

2. The battery pack according to claim 1, wherein in at least one of the pair of first side walls of the battery case, each of positions facing vertex parts of the pair of curved regions is pressed by the pressing member.

3. The battery pack according to claim 1, wherein
the pressing member includes a protrusion part with a dot shape or a stripe shape at the part facing the flat region, and
in at least one of the pair of first side walls of the battery case, the part facing the flat region is pressed by the protrusion part.

4. The battery pack according to claim 1, wherein in at least one of the pair of first side walls of the battery case, each of the entire parts facing the pair of curved regions is pressed by the pressing member.

5. The battery pack according to claim 1, wherein in at least one of the pair of first side walls of the battery case, when an area ratio of a region pressed by the pressing member in the part facing the flat region is Ax % and an area ratio of regions pressed by the pressing member in the parts facing the pair of curved regions is Ay %, a difference between Ax and Ay (Ay-Ax) is 50% or more.

6. The battery pack according to claim 1, wherein in at least one of the pair of first side walls of the battery case, a part ranging from the part facing the curved region to a part that does not face the curved region and the flat region is pressed in the band shape along the winding axis by the pressing member.
